(19) United States
(12) Patent Application Publication
(10) Pub. No.: US 2025/0276380 A1
(43) Pub. Date: Sep. 4, 2025

(54) IN-SITU MICROSTRUCTURAL MONITORING

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,258

(22) Filed: Mar. 1, 2024

(51) Int. Cl. B22F 12/90; B22F 10/28; B22F 10/36; B22F 10/37; B23K 26/03; B23K 26/342; B23K 26/70; B33Y 10/00; B33Y 30/00; B33Y 50/02

(52) U.S. Cl. CPC B22F 12/90; B22F 10/28; B22F 10/36; B22F 10/37; B23K 26/032; B23K 26/342; B23K 26/702; B33Y 10/00; B33Y 30/00; B33Y 50/02

(57) ABSTRACT

An additive manufacturing system includes an energy delivery device configured to deliver energy to a build surface of a component to form a melt pool in the build surface of the component, a powder delivery device configured to direct a powder stream toward the melt pool, a microstructural monitoring device configured to capture data representative of a microstructure of at least a portion of the component; and a computing device. The computing device is configured to receive data from the microstructural monitoring device, and control at least one of the powder delivery device or the energy delivery device based at least partially on the data received from the microstructural monitoring device.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures.

### SUMMARY

In some examples, the disclosure describes an additive manufacturing system which includes a first energy delivery device configured to deliver energy to a build surface of an additively-manufactured component to form a melt pool in the build surface of the component, a second energy delivery device configured to deliver energy to the build surface of the additively-manufactured component, a powder delivery device configured to direct a powder stream toward the melt pool, at least one heat sensor configured to measure a temperature of a portion of the component, and a computing device. The computing device is configured to receive data from the at least one heat sensor captured at a first point in time and captured at a second point in time. The computing device is further configured to determine a thermal history of the component based at least partially on the received data captured at the first point in time and the received data received data captured at the second point in time, and control the first energy delivery device or the second energy delivery device based at least partially on the determined thermal history.

In some examples, the disclosure is directed to techniques which include receiving, by a computing device, data captured at a first point in time from at least one heat sensor of an additive manufacturing system. The heat sensor is configured to measure a temperature of a portion of a component being additively-manufactured. The additive manufacturing system comprises a powder delivery device configured to direct a powder stream toward melt pool in a build surface of the additively-manufactured component, a first energy delivery device configured to deliver energy to the build surface of a component to form the melt pool, and second energy delivery device configured to deliver energy to the build surface, each mass sensor associated with a portion of the additive manufacturing system. The technique includes receiving, by the computing device, data captured at a second point in time from the at least one heat sensor and determining, by the computing device, a thermal history of the portion of the component based at least partially on the received data captured at the first point in time and the received data captured at the second point in time. The technique further includes controlling, by the computing device, the first energy delivery device or the second energy delivery device based at least partially on the determined thermal history of the component.

In some examples, the disclosure describes an additive manufacturing system which includes a first energy delivery device configured to deliver energy to a build surface of a component to form a melt pool in the build surface of the component, a powder delivery device configured to direct a powder stream toward the melt pool, and a second energy delivery device configured to deliver energy to the build surface of the component. The additive manufacturing system further includes a stage configured to support an additively-manufactured component, at least one heat sensor configured to capture data indicative of a temperature of a portion of a component, and one or more computing devices. The computing device or devices are configured to receive data from the plurality of heat sensors, and control the first or the second energy device based at least partially on the received data from the plurality of heat sensors to provide functionally-graded characteristics to the additively-manufactured component, in-situ, through modification of the amount of thermal energy delivered by the first energy delivery device or the second energy delivery device.

In some examples, the disclosure is directed to a technique which includes a method which includes receiving, by one or more computing devices, data from at least one heat sensor configured to measure a temperature of an additive manufacturing system, wherein the additive manufacturing system comprises a powder delivery device configured to direct a powder stream toward a melt pool in a build surface of an additively-manufactured component mechanically supported by a stage, a first energy delivery device configured to deliver energy to the build surface of a component to form the melt pool, a second energy delivery device configured to deliver energy to the build surface of the component. The technique includes controlling, by the one or more computing devices, the first or the second energy device based at least partially on the received data from the at least one heat sensor to provide functionally-graded characteristics to the additively-manufactured component, in-situ, through modification of the amount of thermal energy delivered by the first energy delivery device or the second energy delivery device.

In some examples, the disclosure describes a functionally-graded, additively-manufactured component. The functionally-graded, additively-manufactured component includes a layer-by-layer built component body formed by directing, via one or more computing devices, a powder deliver device to deliver a powder stream toward a melt pool on a build surface of the component body, wherein the component body is mechanically supported by a stage, and wherein the melt pool is formed by energy from a first energy delivery device. The component body comprises a first portion and a second portion, the first portion and the second portion differing in at least one of a strength, a hardness, a ductility, or a microstructure. Forming the first portion and the second portion comprises receiving data from at least one heat sensor indicative of a temperature of a portion of the component, and modifying the amount of energy delivered by the first energy delivery device or a second energy device based at least partially on the received data from the at least one heat sensor to form the first portion and the second portion of the component body in-situ.

In some examples, the disclosure is directed to an additive manufacturing system which includes an energy delivery device configured to deliver energy to a build surface of a component to form a melt pool in the build surface of the component and a powder delivery device configured to direct a powder stream toward the melt pool. The additive manufacturing system also includes a microstructural monitoring device configured to capture data representative of a microstructure of at least a portion of the component and a computing device. The computing device is configured to receive data from the microstructural monitoring device, and control at least one of the powder delivery device or the energy delivery device based at least partially on the data received from the microstructural monitoring device.

In some examples, the disclosure is directed to a method which includes receiving, by a computing device of an additive manufacturing system, data representative of at least a portion of a component being built from a microstructural monitoring device of the additive manufacturing system. The additive manufacturing system further includes a powder delivery device configured to direct a powder stream toward a melt pool in a build surface of an additively-manufactured component and an energy delivery device configured to deliver energy to the build surface of the additively-manufactured component to form the melt pool. The method includes controlling, by the computing device, at least one of the powder delivery device or the energy device based at least partially on the received data from the microstructural monitoring device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating aspects of an example additive manufacturing system that includes a powder source mass sensor, a powder flow monitoring system, a topology sensor, a microstructural monitoring device, a first energy delivery device, a second energy delivery device, and a computing device configured to control the additive manufacturing system during an additive manufacturing technique.

FIG. 2 is a conceptual and schematic diagram illustrating further aspects of the additive manufacturing system of FIG. 1.

FIG. 3 is a conceptual diagram illustrating an example of portions of a powder stream imaged by a powder flow monitoring system.

FIG. 4 is an example calibration curve of particle detections versus mass flow.

FIG. 5 is a conceptual block diagram illustrating portions of the example additive manufacturing system of FIG. 1, including an optical system for observing thermal emissions around a melt pool and a thermal camera for monitoring a size of the melt pool.

FIG. 6 is a conceptual block diagram illustrating an example optical system for observing thermal emissions around a melt pool formed during the additive manufacturing technique.

FIG. 7 is a process flow diagram illustrating a mass flux monitoring, heat flux monitoring, and microstructural monitoring and control technique.

FIG. 8 is a conceptual and schematic diagram illustrating an additively-manufactured, functionally-graded component.

FIG. 9 is a flow diagram illustrating an example technique according to the present disclosure.

FIG. 10 is a flow diagram illustrating an example technique according to the present disclosure.

FIG. 11 is a flow diagram illustrating an example technique according to the present disclosure.

### DETAILED DESCRIPTION

The disclosure generally describes techniques and systems for monitoring mass flux and heat flux in a blown powder additive manufacturing technique, such as a directed energy deposition (DED) technique. During blown powder additive manufacturing, a component is built up by adding material to the component in sequential layers. The final component is composed of a plurality of layers of material. In some blown powder additive manufacturing techniques for forming components from metals or alloys, an energy source may direct energy at a substrate to form a melt pool. A powder delivery device may deliver a powder to the melt pool, where at least some of the powder at least partially melts and is joined to the melt pool and, thus, the substrate.

The properties of the final component, including the presence or absence of material defects and the resulting microstructure, are a function of a number of variables related to mass flux and heat flux. As such, measurement, modeling, control, and validation of mass flux and heat flux within the blown powder additive manufacturing system may enable characterization or prediction of final component properties, control of the blown powder additive manufacturing technique during the process, quality assurance for the final component, development of new blown powder additive manufacturing techniques, and the like.

Several challenges may arise while performing additive manufacturing techniques with additive manufacturing systems. For example, in some cases additively-manufactured components may require complex heat treatments post-deposition (e.g., after the component has been manufactured to substantially the final shape) to achieve required properties. Post deposition heat treatments may be costly and time consuming to perform, and may add additional steps to a manufacturing process. Furthermore, such post-deposition heat treatments may be difficult to perform locally, such as on a repaired component, because heat treatments may lead to deformation of non-repaired areas. Example components may include, but are not limited to, for example, seal segments, shrouds, combustion tubes, blade tracks, disc assemblies, airfoils (e.g., blades or vanes), combustion chamber liners, or the like, of a gas turbine engine.

Where the additively-manufactured component is a compressor blade, as one example, different material properties may be desirable at different portions of the blade. For example, different portions of the blade may include different stresses along the length during operation of a gas turbine engine. High ductility may be desirable at radially outer (relative to an engine centerline) portions of the blade, while high hardness may be desirable at a leading edge. It may be difficult to impart desired properties to specific areas of the blade as a post-process. It should be noted that turbine blades are not the only components where different material properties, attainable by heat-treatment or controlled cooling, are desirable, and the disclosed systems and techniques may be useful for additively manufacturing such components in-situ. For example, any rotative component or component that requires a harder surface to resist wear but also needs ductility elsewhere (e.g., gears, transmission components, ablative protective panels, sealing surfaces, or the like) may also be manufactured according to aspects described herein.

In accordance with one or more aspects this disclosure, an additive manufacturing system may be configured to thermally monitor and selectively tailor heat treatment to an additively-manufactured component in-situ (e.g., while the component is being manufactured or before removal of the component from a stage on which the component was additively-manufactured). In this way, rather than requiring post-deposition heat treatment, tailored properties may be delivered to one or more portions of the component while it is being manufactured, which may remove processing steps and/or allow for functional gradation of the component. To perform the thermal monitoring and selective in-situ heat treatment, the additive manufacturing system may include at least one heat sensor configured to capture data indicative of a portion of the component. In some examples, each portion of a component being additively-manufactured may be associated with a corresponding heat sensor configured to monitor the temperature of the portion.

The heat sensor or sensors may be configured to capture data over time (e.g., at a first point in time, a second point in time, a third point in time, etc.), and the captured data may be stored and analyzed by a computing device of the additive manufacturing system. The captured data may correspond to a portion of the additively-manufactured component and/or the system during some or all of the additive manufacturing process. Thus, the captured data from the heat sensor(s) may be used to determine a thermal history of the component (e.g., by comparing the data captured at the first point in time to the data captured at the second point in time). The determined thermal history may be compared to a model, material properties, or the like to determine or predict material properties (e.g., a strength, a hardness, a ductility, a porosity, a microstructure, a cracking behavior, or the like) of the portion of the component. The computing device or devices may receive and store data from additional heat sensors, each corresponding to another portion of the component. In this way, in some examples, a matrix may be generated having the thermal history of different portions of the additively-manufactured component. The computing device may modify energy delivered to the build surface by at least one energy delivery device (e.g., an on-axis laser, an off-axis laser, an induction heater, a microwave heater, a cooling device, or the like) to better align the portion of the component to the desired thermal history. For example, the second energy delivery device may be configured to deliver energy to the portion of the component such that the temperature of the portion is maintained at a desired temperature for a certain length of time, which may correspond to a desired tempering, densification, or the like of the portion of the component. In this way, the additive manufacturing system may be configured to selectively tailor the energy delivered to build a component with the desired properties.

Some components may experience various stress states during service. For example, aerospace components such as those mentioned above may require different properties in different portions of the component due to the expected stresses in the different portions. Functionally-graded components (e.g., differing in strength, ductility, porosity, microstructure, or the like to different portions of the component may be difficult to create through conventional manufacturing techniques, and/or may require one or more post-processes (e.g., heat treatment) to modify (e.g., temper) selected portions of the component or otherwise impart desired characteristics to particular areas.

In accordance with one or more aspects of the present disclosure, functionally-graded components may be additively-manufactured in-situ using systems and techniques capable of imparting desired material properties at selected portions of the component. The disclosed systems and techniques may be used to generate advanced components capable of handling different types of stresses during operation. A functionally-graded, additively-manufactured component may be a component formed through a layer-by-layer deposition process. Modification of energy delivered to different portions of the component by a first energy delivery device or a second energy delivery device may be used to generate the functionally-graded component. Put differently, the component may be heat-treated in-situ to create portions of the component that have different properties, such as a first portion, a second portion, a third portion, or the like. The first portion, the second portion, and other portions may differ in one or more of a strength, a ductility, a porosity, a microstructure, a modulus of elasticity, or the like.

As mentioned above, conventional directed energy deposition systems or other additive manufacturing systems may require post-processing to impart different functional characteristics to different portions of the component. In accordance with one or more aspects of the current disclosure, additive manufacturing systems may include more than one energy delivery device. Inclusion of a second energy delivery device, an optional third energy delivery device, and/or a cooling device (e.g., configured to remove thermal energy from the build surface of the component) may allow for selective tailoring of the energy delivered to desired portions of the component to change the properties of the portion in-situ, thereby reducing or eliminating the need for post-process heat treatment.

In some examples, a primary energy delivery device may be a laser associated with the deposition head of the additive manufacturing system that forms a melt pool in a build surface of the component for material deposition. In some examples, the primary (or “first”) energy delivery device may be located coincident with a central longitudinal axis of the deposition head. Secondary and/or tertiary energy delivery device may be configured to add or remove energy to other localities on the build surface (e.g., by one or more off-axis lasers) or by another energy delivery device, (e.g., an induction heater, an infrared heater, gas impingement system, a microwave heater, or the like) which may be configured to deliver energy to particular localities on the component or globally to the component. In some examples, such secondary and/or tertiary energy delivery devices may be displaced from the central longitudinal axis of the deposition head, and thus be called “off-axis.” In some examples, secondary and/or tertiary energy delivery devices may be configured to preheat a portion of the component prior to formation of the melt pool in the portion by the primary energy delivery device. In some examples, secondary and/or tertiary energy delivery devices may deliver energy to the build surface simultaneously to the primary energy delivery device delivering energy to the build surface. Similarly, the secondary and/or tertiary energy delivery devices may be configured to deliver energy after (e.g., subsequent to) the primary energy delivery device forming the melt pool on the build surface. In this way, a cooling rate (e.g., a solidification rate) of the layer after the primary energy delivery device passes may be controlled by modification of energy delivered by one or more supplemental energy delivery devices.

In accordance with one or more aspects of this disclosure, an additive manufacturing system may include a plurality of sensors for sensing mass flow at various points along the powder flow and at least one heat sensor for sensing heat flow within the system. For instance, the mass flow sensors may include a mass sensor associated with a powder source, a powder flow monitoring system sensing powder flow between an output of a powder delivery device and the melt pool, and a topology sensor for measuring a topology of material added to the melt pool. The at least one heat sensor may include at least one sensor for monitoring a size and/or temperature of the melt pool, and at least one heat sensor (e.g., temperature probe) for monitoring a heat flow (e.g., cooling rate or a sonification rate) around the melt pool. The sensors may output data to a computing device, which may analyze and/or controls the additive manufacturing system based on the received sensor data. By monitoring mass flow at different points along the powder flow and monitoring heat flow in multiple ways, the system described herein may enable a more complete understanding of mass and heat flux within the system. Additionally, in some examples, the computing device may control the first or the second energy device based at least partially on the received data from the at least one heat sensor to provide functionally-graded characteristics to the additively-manufactured component, in-situ, through modification of the amount of thermal energy delivered by the first energy delivery device or the second energy delivery device.

Additively-manufactured components may be subject to quality risks during manufacture. For examples, contaminants or agglomerations in powder in a stream of powder may be delivered to the melt pool and incorporated into the component, or splatter may evacuate the melt pool and adhere improperly to the build surface, or the like. In conventional systems, destructive testing and/or extensive quality assurance testing after manufacturing the component may be required to ensure that the component meets microstructural quality standards. Where destructive testing is employed, complete quality assurance may not be ensured because the microstructure may vary during a single build or deposit.

In accordance with one or more examples of the current disclosure, additive manufacturing systems and techniques may incorporate one or more microstructural monitoring devices configured to capture data representative of the component's microstructure in-situ (e.g., during the build). The microstructural monitoring device may include, for example, an X-Ray device, a computed tomography (CT) device, a magnetic resonance imaging (MRI) device, an ultrasound device, another acoustic monitoring device, or the like. Accordingly, the data captured by the microstructural monitoring may be representative of a layer or portion of the component being additively manufactured, and the data may be output by the microstructural monitoring device to the computing device for analysis and/or control of the additive manufacturing system. For example, a modulus of elasticity, a microstructural texture, a porosity, and/or a cracking behavior of the component may be determined by the computing device based at least partially on the data captured by the microstructural monitoring device. Based at least partially on the data captured by the microstructural monitoring device, the computing device may modify one or more of the power delivered to the energy delivery device(s), the travel speed of the deposition head, the spot size of the primary energy delivery device, the power density, shielding gas flow rates, powder delivery gas flow rate, the build strategy, or other parameters to control the microstructure of the component while the component is being built. Furthermore, the computing device may be configured to stop the build, or output a representation of a microstructure failing to meet a threshold setting, if an anomaly or problem is detected (e.g., the data captured by the microstructural does not conform to the expected values). The problem may be addressed before the build is continued, which may save time and repair costs. In this way, the microstructure of the component may be determined in-situ and used to inform and/or control a build strategy. In some examples, the microstructural monitoring device or computing device may house a machine learning algorithm, and the machine learning algorithm may be trained on data generated by the microstructural monitoring device. For example, the machine learning algorithm may be used to correlate the data generated by the microstructural monitoring device to data indicative of materials quality of powder in the powder stream. In this way, in-situ microstructural monitoring of an additively-manufactured component may be used to validate, modify, or stop an additive manufacturing process.

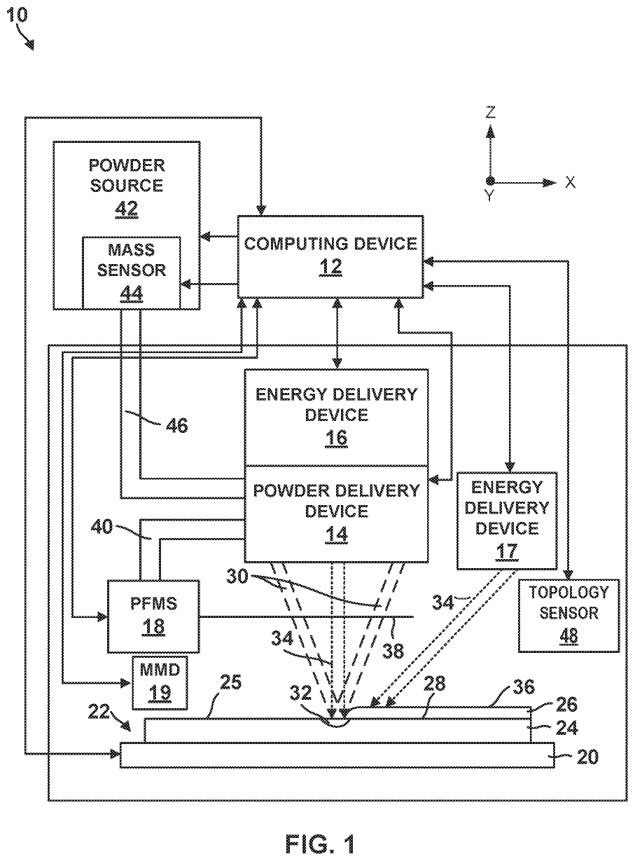

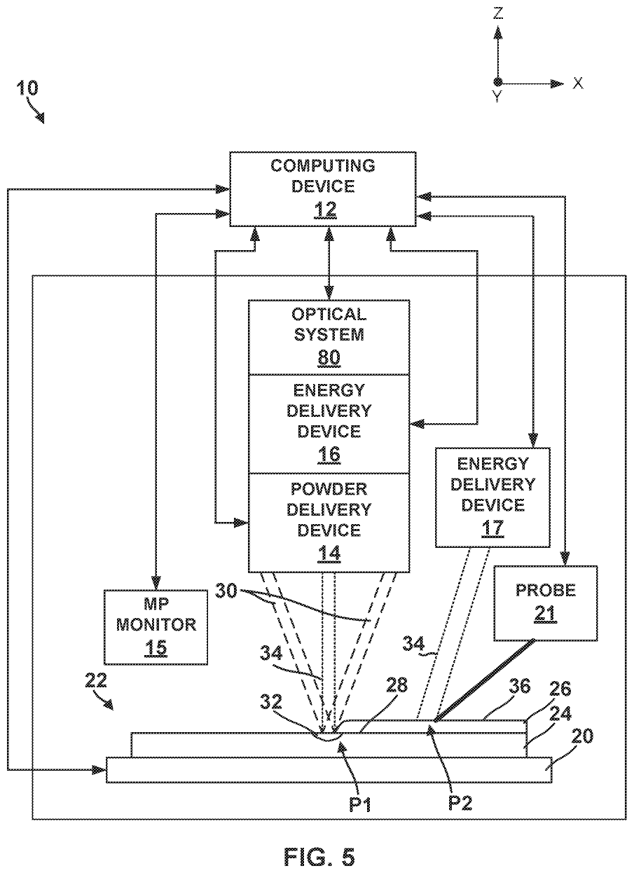

FIG. 1 is a conceptual block diagram illustrating aspects of an example additive manufacturing system 10. Additive manufacturing system 10 includes several components configured to monitor mass flow, and several components configured to monitor energy (e.g., heat flux) within system 10. System 10 includes a powder source mass sensor 44, a powder flow monitoring system (PFMS) 18, and a topology sensor 48. These components are configured to monitor mass flow of powder within additive manufacturing system 10 during an additive manufacturing technique. In the example illustrated in FIG. 1, additive manufacturing system 10 further includes a computing device 12, a powder delivery device 14, a first or primary energy delivery device 16, a second or secondary energy delivery device 17, a stage 20, a powder source 42, powder source mass sensor 44, topology sensor 48, and microstructural monitoring device (MMD) 19. Computing device 12 is operably connected to powder delivery device 14, energy delivery devices 16 and 17, PFMS 18, stage 20, powder source 42, powder source mass sensor 44, topology sensor 48, and MMD 19. FIG. 1 thus illustrates mass flow monitoring and other aspects of example additive manufacturing system 10. To simplify illustration of FIG. 1 and improve clarity of the figure, further aspects of additive manufacturing system 10 are shown in FIG. 5 and described below with reference to FIG. 5, which is more directed toward heat flow aspects of system 10.

Stage 20 is configured to mechanically support a component 22 during an additive manufacturing technique. Component 22 may be considered in-situ when mechanically supported by stage 20. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. For example, stage 20 may be translatable and/or rotatable along at least one axis to position component 22 relative to energy delivery device 16 and/or powder delivery device 14. Similarly, energy delivery device 16 and/or powder delivery device 14 may be translatable and/or rotatable along at least one axis to position energy delivery device 16 and/or powder delivery device 14, respectively, relative to component 22. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream.

System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder. The combined powder defines powder stream 30. In some examples, powder delivery device 14 includes a single nozzle, which may be point nozzle, or a single nozzle that is an annular channel. In other examples, powder delivery device 14 includes a plurality of nozzles (e.g., three nozzles or four nozzles). Regardless of the number of nozzles, powder delivery device 14 may output a powder stream that is focused at a focus plane. As powder delivery device 14 is movable in the z-axis shown in FIG. 1 relative to component 22, the focal plane of powder delivery device 14 also may be movable in the z-axis relative to component 22, such that the focus plane may be controlled to be substantially coincident with build surface 28.

At least some of the powder in powder stream 30 may impact a melt pool 32 in component 22. At least some of the powder that impacts melt pool 32 may be joined to component 22. In some examples, powder delivery device 14 may be mechanically coupled or attached to primary energy delivery device 16 to facilitate delivery of powder stream 30 and energy 34 for forming melt pool 32 to substantially the same location adjacent to component 22.

Primary energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, primary energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22. Primary energy delivery device may be configured to focus energy 34 from the energy source on a local spot on build surface 28 to generate melt pool 32.

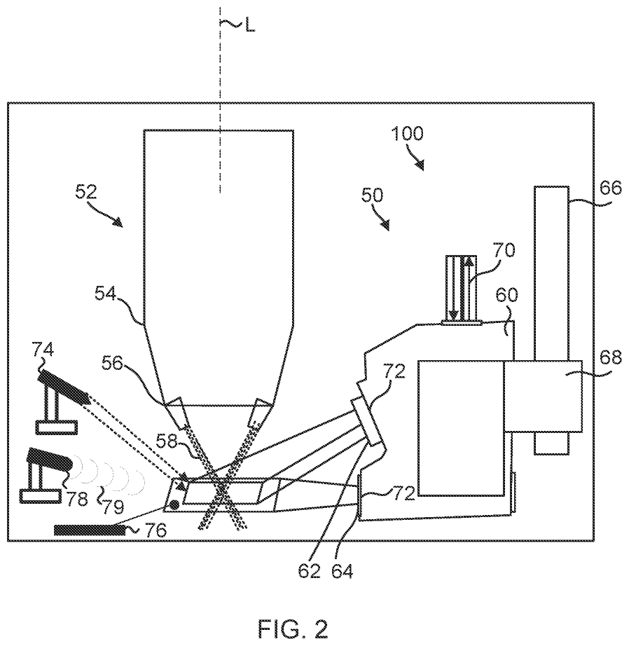

In some examples, at least a portion of primary energy delivery device 16 and powder delivery device 14 may be combined or attached to each other. For example, a deposition head (e.g., deposition head 54 of FIG. 2) may include part of powder delivery device 14 (e.g., internal channels and powder nozzle(s) 56 for forming powder stream 30 and directing powder stream 30 toward build surface 28) and part of primary energy delivery device 16 (e.g., the energy delivery head). As shown in FIG. 1, in some examples, primary energy delivery device 16 may be arranged of configured such that energy 34 and powder stream 30 both exit from a common deposition head (54, FIG. 2) and are directed toward build surface 28. For instance, energy 34 may pass through a central channel (e.g., formed along central longitudinal axis L, FIG. 2) within the deposition head and exit a central aperture in the deposition head, while fluidized powder may flow through internal channels and powder nozzle(s) 56 for forming powder stream 30 and directing powder stream 30 toward build surface 28. Such an arrangement between primary energy source 16 and powder delivery device 14 may be called an “on-axis” arrangement of primary energy source 16, because both energy and powder may be delivered coaxially with a central longitudinal (Z-direction) axis of the deposition head.

System 10 also includes powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light source. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28 (e.g., central longitudinal axis L).

The imaging device of PFMS 18 is configured to image at least some of the illuminated powder. The imaging device may have a relatively high data acquisition speed (e.g., frame rate), such greater than 1000 Hz. Because of the velocity of the powder in powder stream 30, even such a frame rate may image only a fraction of the powder flowing between powder delivery device 14 and build surface 28.

In some examples, PFMS 18 also includes a housing configured to enclose the illumination device and the imaging device. The housing may be configured to protect the illumination device and the imaging device from damage due to the harsh conditions to which PFMS 18 may be exposed during use. For example, the housing may protect the illumination device and the imaging device from powder deflections from powder stream 30 off build surface 28, may cool the illumination device and the imaging device to remove heat incident on PFMS 18 from melt pool 32 and energy delivery device 16, or the like.

PFMS 18 may be positionally fixed relative to powder delivery device 14 and/or energy delivery device 16, e.g., in the x-y plane shown in FIG. 1. This may help maintain a relative x-y position of PFMS 18 and the image plane of the imaging device relative to powder stream 30. This may facilitate analysis of image data captured by the imaging device.

PFMS 18 may be movable in the z-axis direction of FIG. 1 (e.g., parallel to a longitudinal axis extending from powder delivery device 14 to build surface 28). This may enable movement of image plane 38 along the z-axis of FIG. 1 (e.g., parallel to a longitudinal axis extending from powder delivery device 14 to build surface 28). This may allow PFMS 18 to image powder stream 30 at different positions between powder delivery device 14 and build surface 28. In this way, PFMS 18 may analyze powder stream 30 along powder stream 30 to help determine parameters of powder stream 30 along its length.

In some example, PFMS 18 may be positionally fixed relative to powder delivery device 14 and/or energy delivery device 16 and movable parallel to a longitudinal axis extending from powder delivery device 14 to build surface 28 by an adjustable z-stage 40. Adjustable z-stage 40 may be attached to energy delivery device 16, powder delivery device 14, or a portion of system 10 that moves energy delivery device 16 and/or powder delivery device 14, such that PFMS 18 moves in the x-y axis in registration with energy delivery device 16 and/or powder delivery device 14.

Adjustable z-stage 40 may be controlled by computing device 12 to position PFMS 18 and image plane 38 relative to powder stream 30. Further, computing device 12 may control adjustable z-stage 40 to move PFMS 18 vertically and out of the way to allow powder delivery device 16 and energy delivery device 16 access to physically constrained areas, e.g., between vanes of a doublet or triplet of a nozzle guide vane for a gas turbine engine.

System 10 further includes a topology sensor 48. Topology sensor 48 is configured to monitor an amount of powder captured by melt pool 32 by imaging melt pool 32 and the added material, allowing the mass to be quantified (e.g., by computing device 12) using the dimensions of the added material and density of the material (powder). In some examples, topology sensor 48 includes a laser and a sensor (e.g., an imaging device), which senses laser light reflected by the structure being imaged (e.g., melt pool 32 and the added material). The laser may have a defined wavelength, which may affect the resolution of the topology sensor 48. In some examples, the wavelength and sensor may be selected such that the resolution of topology sensor 48is a great as about 10 microns (e.g., about 6 microns).

In some examples, topology sensor 48 may be positioned substantially directly above component 22 and may include an interferometer, which provides depth information based on the time from outputting a laser pulse to the sensing of the reflected light. In other examples, topology sensor 48 may be positioned at an offset with respect to component 22 such that the sensor senses depth information without using an interferometer.

In some examples, topology sensor 48 may be integral with system 10, e.g., disposed within the enclosure or working area of system 10. In other examples, topology sensor 48 may be an add-on component to system 10. For example, the enclosure in which the additive manufacturing technique is performed may include a transparent window, and topology sensor 48 may be positioned outside of the enclosure and may image component 22 through the transparent window.

Although a topology sensor 48 is described in the examples of this disclosure, in other examples, another metrology device may be utilized to determine the amount of powder captured by melt pool 32. For example, another type of light source may be used. In some examples, if another type of light source is used, component 22 or stage 20 may include one or more features that serve as indicators of scale. Furthermore, although described as a single topology sensor 48, more than one sensor may be used, and may employ more than one of the technologies described above.

System 10 further includes secondary energy delivery device 17. In some examples, secondary energy device 17 may include an energy source and energy delivery head as described above with respect to primary energy delivery device 16. As such, secondary energy delivery device 17 may be configured to deliver energy 34 to a second spot on build surface 28, as will be further described below. In some examples, secondary energy delivery device 17 may be displaced from a central longitudinal axis of the deposition head, and thus may be called an “off-axis” energy source. Alternatively, secondary energy delivery device may be configured to deliver energy globally to component 22 (e.g., the entire component body 22). Furthermore, although it is considered that the energy source for secondary energy delivery device 17 may be a laser, other sources of energy are considered. For example, the energy source for secondary energy delivery device 17 may include one or more of an induction heater, an infrared heater, a microwave heater, a fan or blower system configured to deliver hot gases to build surface 28, or the like.

System 10 includes microstructure monitoring device (MMD) 19. MMD 19 may be configured to capture data representative of the microstructure of component 22 in-situ, and output the captured data to computing device 12. MMD 19 may include an imaging sensor such as an X-Ray device, a computed tomography (CT) device, a magnetic resonance imaging (MRI) device, or the like. Additionally, or alternatively, MMD 19 may include an acoustic sensing system such as an ultrasound device. Although illustrated as an off-axis add-on to system 10, in some examples MMD 19 may be part of a deposition head and be arranged on-axis.

Computing device 12 is configured to control components of system 10 and may include, for example, a desktop computer, a laptop computer, a workstation, a server, a mainframe, a cloud computing system, or the like. Computing device 12 is configured to control operation of system 10, including, for example, powder delivery device 14, primary energy delivery device 16, secondary energy delivery device 17, PFMS 18, stage 20, powder source 42, powder source mass sensor 44, topology sensor 48, and/or MMD 19. Computing device 12 may be communicatively coupled to powder delivery device 14, energy delivery device 16, PFMS 18, stage 20, powder source 42, powder source mass sensor 44, and/or topology sensor 48 using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like.

Although FIG. 1 illustrates a single computing device 12 and attributes all control and processing functions to that single computing device 12, in other examples, system 10 may include multiple computing devices 12, e.g., a plurality of computing devices 12. In general, control and processing functions described herein may be divided among one or more computing devices. For instance, system 10 may include a controller for energy delivery devices 16 and 17, powder delivery device 14, and stage 20, a separate controller for PFMS 18, and a separate computing device for analyzing data obtained by PFMS 18, mass sensor 44, topology sensor 48, and MMD 19. As another example, system may include a dedicated controller for each of primary energy delivery device 16, secondary energy delivery device 17, powder delivery device 14, stage 20, PFMS 18, topology sensor 48, and MMD 19, and a separate computing device for coordinating control of powder delivery device 14, energy delivery device 16, PFMS 18, stage 20, powder source 42, powder source mass sensor 44, and/or topology sensor 48 and analyzing data obtained by PFMS 18 powder source mass sensor 44, and/or topology sensor 48. Other examples of computing system architectures for controlling system 10 and analyzing data obtained from system 10 will be apparent and are within the scope of this disclosure.

Computing device 12 may be configured to control operation of powder delivery device 14, primary energy delivery device 16, secondary energy delivery device 17, adjustable z-stage 40, stage 20, and/or topology sensor 48 to position component 22 relative to powder delivery device 14, energy delivery device 16, PFMS 18, topology sensor 48, and MMD 19. For example, as described above, computing device 12 may control stage 20 and powder delivery device 14, primary energy delivery device 16, secondary energy delivery device 17, adjustable z-stage 40, topology sensor 48, and/or MMD 19 to translate and/or rotate along at least one axis to position component 22 relative to powder delivery device 14, energy delivery devices 16 and 17, PFMS 18, topology sensor 48, and MMD 19. Positioning component 22 relative to powder delivery device 14, energy delivery devices 16 and 17, PFMS 18, topology sensor 48, and MMD 19 may include positioning a predetermined surface (e.g., a surface to which material is to be added) of component 22 in a predetermined orientation relative to powder delivery device 14, energy delivery device 16, PFMS 18, topology sensor 48, and/or MMD 19.

Computing device 12 may be configured to control system 10 to deposit layers 24 and 26 to form component body 25 and eventually finished component 22. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques. Although techniques are described herein with respect to component 22 including first layer 24 and second layer 26, the technique may be extended to components 22 with more complex geometry and any number of layers. Furthermore, although component 22 is illustrated as being uniform, in some examples component 22 may be functionally-graded and include at least two different portions having different selectively tailored properties, as will be further illustrated and described below.

To form component 22, computing device 12 may control powder delivery device 14, primary energy delivery device 16, and secondary energy delivery device 17 to form, on a surface 28 of first layer of material 24, a second layer of material 26 using an additive manufacturing technique. Computing device 12 may control primary energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32. Computing device 12 may control powder delivery device 14 and primary energy delivery device 16 to move energy 34 and powder stream 30 along build surface 28 in a pattern until layer 26 is complete. Computing device 12 may control secondary energy delivery device 17 to deliver energy to a portion of build surface 28 to modify the cooling rate, solidification behavior, or other aspects of the thermal profile of component 22 determined based on data from a plurality of heat sensors (not illustrated in FIG. 1 for clarity) associated with portions of component 22. The plurality of heat sensors may be configured to capture and store data during the build (e.g., at a first point in time, a second point in time, a third point in time, etc.). Computing device 12 may determine, based on the captured data by the plurality of heat sensors, the thermal history of component 22 and compare the thermal history to a model or preform a calculation to correlate the thermal history of component 22 relative to the thermal history of a component with desired characteristics or properties (e.g., strength, ductility, porosity, microstructure, or the like). Computing device 12 may then modify one or more of the magnitude, power density, travel speed, or spot size (i.e., focus area) of primary energy delivery device 16 or secondary energy delivery device 17 to generate a portion of component 22 (e.g., all or a portion of layer 26) to selectively tailor the characteristics of the portion based on the thermal history of the portion. For example, computing device 12 may cause second energy delivery device 17 to pause, dwell, or skip certain portions of build surface 28 to generate a desired microstructure. Computing device 12 may cause MMD 19 to capture data representative of a microstructure of layer 26. Computing device 12 may then analyze the captured microstructure data to determine whether the captured microstructure data meets a threshold (e.g., a threshold density, a threshold porosity, a threshold uniformity, or the like). In this way, functionally-graded, additively-manufactured component 22 may be generated by system 10 in-situ, and the

Computing device 12 then may control a z-axis position of stage 20 and/or powder delivery device 14 and primary energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete. Computing device 12 may control powder delivery device 14 and energy delivery device 16 similarly until all layers are formed to define a completed component 22.

In some examples, computing device 12 may store/execute one or more machine learning models which may be used to adapt control of powder delivery device 14, primary energy delivery device 16, secondary energy delivery device 17, or another component. For example, data captured by first energy delivery device 16, second energy delivery device 17, MMD 19, PFMS 18, topology sensor 48, mass source 44, or other component may be used to train the machine learning device. In some examples, the machine-learning algorithm may be used to correlate the data generated by MMD 19 with data indicative of materials quality of powder in the powder stream.

FIG. 2 is a conceptual and schematic diagram illustrating example additive manufacturing system 100. Additive manufacturing system 100 of FIG. 2 may be an example of additive manufacturing system 10 of FIG. 1. System 100 includes an example powder flow monitoring system 50 configured to monitor powder flow between a powder delivery device 52 and a build surface (not shown in FIG. 2) during an additive manufacturing technique. Powder delivery device 52 may be an example of powder delivery device 14 of FIG. 1, and PFMS may be an example of PFMS 18 of FIG. 1.

Powder delivery device 52 includes a deposition head 54 that carries a plurality of powder nozzles 56. Plurality of powder nozzles 56 output a powder stream 58 toward the build surface. As shown in FIG. 2, the powder stream 58 may be focused at a focal plane, such that powder stream 58 is converging toward the focal plane and diverging away from the focal plane. As discussed above, deposition head 54 may further include a primary energy delivery device, which is not illustrated in FIG. 2 for improved clarity.

PFMS 18 includes a housing 60 (also referred to as an enclosure), which encloses an imaging device 62 and an illumination device 64. In some examples, imaging device 62 may be a high-speed camera and illumination device 64 may be laser illuminator. Housing 60 is attached to an adjustable z-stage 66 by a bracket 68.

Housing 60 is configured to enclose imaging device 62 and illumination device 64 and help protect imaging device 62 and illumination device 64 from a surrounding environment. For instance, housing 60 may be configured to surround imaging device 62 and illumination device 64 and prevent any powder that reflects from the build surface toward PFMS 18 from impacting imaging device 62 or illumination device 64.

Further, housing 60 may be configured to cool imaging device 62 and illumination device 64. Imaging device 62 and illumination device 64 may be exposed to heat from the melt pool at the build surface and energy from the energy delivery device. Imaging device 62 and illumination device 64 may be relatively sensitive to heat and have improved operational lifetime if maintained and operated below a certain temperature. PFMS 50 may include a cooling system 70 configured to remove heat from within housing 60 to cooling imaging device 62 and illumination device 64. For instance, cooling system 70 may include cooling fluid circuit through which a cooling fluid flows, and housing 60 may include part of the cooling circuit. In some examples, housing 60 may be formed from a material having relatively high thermal conductivity, such as aluminum, to help transfer heat from within housing 60 to cooling system 70 (e.g., a cooling fluid flowing through cooling system 70).

As described above, PFMS 50 may be configured to measure powder flow of powder stream 58 (FIG. 2) at one or more axial (or longitudinal) locations of powder stream 58 and determine one or more parameters associated with the powder flow. For instance, illumination device 64 may illuminate powder of powder stream 58 in a plane oriented substantially orthogonal to a longitudinal axis that extends from powder delivery device 52 to the build surface. PFMS 50 may be positioned at a selected axial or longitudinal location to image a selected axial or longitudinal position between powder delivery device 52 and the build surface. Imaging device 62 may be configured to image at least some of the illuminated powder.

Included in the illustration of system 100 of FIG. 2 are secondary energy delivery device 74, MMD 78, and tertiary energy delivery device 76. Secondary energy delivery device 74 may be a laser configured to deliver energy locally to a portion of the additively-manufactured component. Tertiary energy delivery device 76, in the illustrated example, is an induction heater configured to add thermal energy to the entire component. It is also considered that tertiary energy delivery 76 could be another type of heater, or even be a cooling device configured to remove thermal energy from the build surface of the additively-manufactured component. In such examples, tertiary energy delivery device 76 may include a heat exchanger. System 100 includes MMD 78. In the illustrated example of FIG. 2, MMD 78 includes an ultrasound probe configured to direct acoustic energy 79 toward the additively manufactured component and receive acoustic energy reflected back from the additively-manufactured component for detection and analysis. Each of secondary energy delivery device 74, MMD 78, and tertiary energy delivery device 76 may be communicatively coupled to and under control of a computing device (12, FIG. 1).

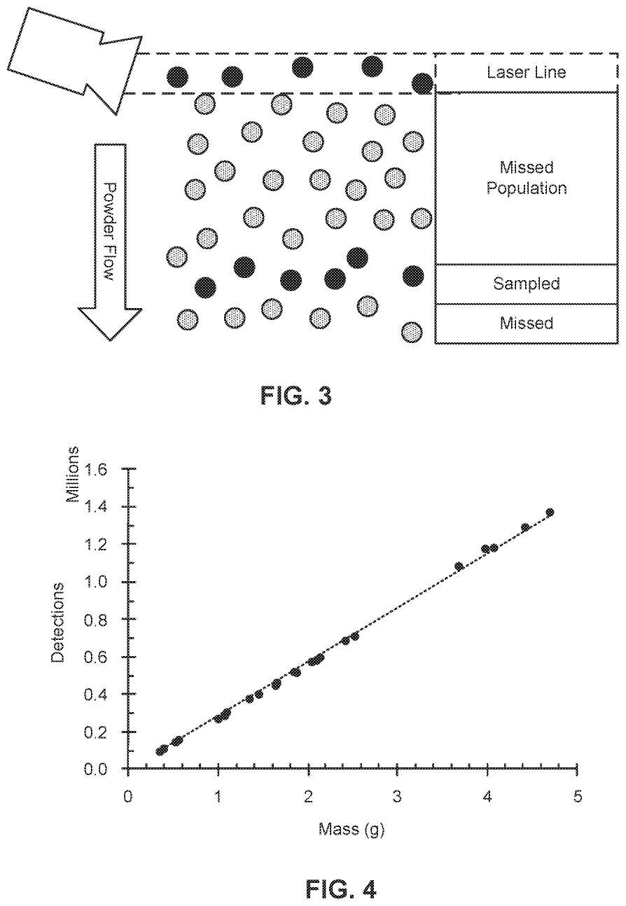

FIG. 3 is a conceptual diagram illustrating an example of portions of a powder stream imaged by a powder flow monitoring system. As shown in FIG. 3, since powder is flowing in powder stream 58 at a relatively high velocity, imaging device 62 may not capture images of all the powder in powder stream 58. The fraction of powder that imaging device 62 captures images of may be a function of average powder velocity at the image plane and a frame rate or capture speed of imaging device 62. This is represented in FIG. 3 as “sampled” particles and “missed population” particles. The fraction of particles imaged by imaging device 62 may, in some examples, be less than about 50%, less than about 40%, less than about 30%, less than about 25%, less than about 20%, or less than about 15%.

PFMS 50 may include a computing device (e.g., computing device 12 of FIG. 1) configured to analyze images captured by imaging device 62 to identify a number of particle detections in each captured image and, optionally, derive further parameters from the number of particle detections. As such, computing device 12 may be configured to receive image data representing an image captured by imaging device 62. The image data may include representations of illuminated powder of powder stream 58, as imaged by imaging device 62 (e.g., as captured in an image frame by imaging device 62). Computing device 12 may be configured to generate a representation of powder stream based on the image data and output the representation of the powder stream for display at a display device.

For instance, computing device 12 may be configured determine a powder mass flow represented by the image data. To do so, computing device 12 may be configured to identify a number of powder particles within each image frame. In some examples, computing device 12 additionally may be configured to identify a size and/or shape of each powder particle within each image frame. Computing device 12 may be configured to implement any suitable image analysis technique to identify powder particles, and, optionally, size and/or shape of powder particles.

Once computing device 12 has identified a number of powder particles within an image frame, computing device 12 may be configured to determine a mass flow based on the number of powder particles. For example, computing device 12 may be configured to determine the mass flow based on a calibration equation or calibration curve. FIG. 5 is an example calibration curve of particle detections versus mass flow. As shown in FIG. 4, the relationship between particle detections may be substantially linear.

The relationship between particle detections and mass flow may be determined experimentally. For instance, the relationship between particle detections and mass flow may be determined for each powder type (e.g., composition, size distribution, or both), as each powder type may have a different relationship between particle detections and mass flow. The relationship may be determined experimentally by flowing a known mass of powder at a known rate, and imaging the powder. By doing this multiple times at multiple rates, the calibration curve may be generated. The curve, in the form of an equation, a look-up table, or the like, may be stored in computing device 12, and computing device 12 may use the calibration curve to determine mass flow of a similar type of powder at a different flow rate based on particle detections.

In some examples, computing device 12 may receive image data representative of a sequence of images of illuminated powder in powder stream 58. Each image may be associated with a time. As such, computing device 12 may select one or more images of the sequence of images and analyze the one or more images. For each selected image, computing device 12 may be configured to identify a number of particle detections and, optionally, determine a mass flow associated with powder stream 58 for each image frame.

As described above, system 10 may include both mass flow monitoring and heat flow monitoring. FIG. 1 best illustrates the mass flow monitoring aspects of system 10. FIG. 5 is a conceptual block diagram illustrating further aspects of system 10, best illustrating the heat flow monitoring aspects of the example system. System 10 includes an optical system 80 for observing thermal emissions around melt pool 32 and a melt pool monitor 15 including a thermal camera for monitoring a size and/or temperature of melt pool 32. Identical reference numerals in FIGS. 1 and 5 refer to the same parts. Further, those common parts are the same or substantially identical, aside from any differences described herein.

As shown in FIG. 5, primary energy delivery device 16 includes an optical system 80. Although optical system 80 is shown and described only as associated with primary energy delivery device 16, secondary energy delivery device 17 may include a corresponding optical system. During additive manufacturing, component 22 is built up by adding material to component 22 in sequential layers. The final component is composed of a plurality of layers of material. Primary energy delivery device 16 may direct energy 34 at portion PI of first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure of the component 22 formed using the additive manufacturing technique.

In some examples, temperature probe 21 may measure a temperature of build surface 28 in portion P2 and output captured temperature information to computing device 12. Although described and illustrated as a temperature probe herein, element 21 may be more generally referred to as heat sensor 21, and is not necessarily be a temperature probe. For example, heat sensor 21 may be configured to sense heat via an optical system, as described elsewhere herein.

Different portions of component 22 may, in some examples, be defined relative to melt pool 32. In such examples, temperature probe 21 may be movable relative to build surface 28 to maintain a spatial relationship to melt pool 32. In such examples, first portion P1 may be defined as encompassing the portion of build surface 28 that defines melt pool 32 (and/or melt pool 32 plus the area within 1.5 radii of melt pool 32, 2.0 radii of melt pool 32, or 3.0 radii of melt pool 32). In such examples. Second portion P2 may be defined as encompassing an area with a radius equal to melt pool 32 but trailing melt pool 32 along build surface 28 relative to a toolpath by, for example, two, four, or six radii of melt pool 32. Other portions (P3, P4, etc.) may be defined leading melt pool 32, orthogonal to melt pool 32, etc., and each portion may have a corresponding temperature probe 21.

Alternatively, portions (P1, P2, etc.) may be defined relative to the expected final dimensions of additively-manufactured component 22. In such examples, probe 21 may be stationary or may be configured to vertically adjust as layers are added to measure a temperature of build surface 28 in same or similar location. Primary energy delivery device 16 may travel through portion P2, forming melt pool 32 as it travels along a toolpath. In such examples, computing device 12 may store instructions for a desired thermal history of each portion (P1, P2, etc.) and modify energy delivered by secondary energy delivery device 17 or a tertiary energy delivery device to conform to the desired thermal history of the component.

Computing device 12 may control secondary energy delivery device 17 to modify the temperature and cooling rate of portion P2 of the build surface 28 by adding energy 34 to portion P2 to ensure that component P2 cools according to the desired thermal history profile, such that resulting component 22 has the desired material properties. In some examples portions P1 and P2 may receive different amounts of thermal energy by primary energy source 16, secondary energy source 17, or both. As such, portion P1 and portion P2 may have a different thermal history, and therefore different resulting properties. For example, portions P1 and P2 may differ in strength, ductility, porosity, microstructure, or the like. Although portions P1 and P2 are described and illustrated as displaced from each other in the X-Y plane, it should also be considered that layer 24 and 26 may be treated, in-situ, by different magnitudes or durations of energy 34 or time periods by first energy delivery device 16 and/or second energy delivery device 17. In such examples, portions P1 and P2 may be displaced from each other in the Z-direction. It should be noted that computing device 12 may control primary energy delivery device and secondary energy delivery device 17 independently based on data from MP monitor 15, optical system 80, probe 21, or combinations thereof. For example, computing device 12 may cause secondary energy delivery device 17 to deliver energy 34 to build surface 28 before, during, and/or subsequent to primary energy delivery device 16 delivering energy 34. Although only portions P1 and P2 are illustrated in FIG. 5, it is considered that additional third, fourth, and fifth portions of component 22 may be similarly monitored and controlled. In some examples, each portion may have a corresponding probe 21 and/or a corresponding energy delivery device.

In many cases, energy 34 output by primary energy delivery device 16 and/or secondary energy delivery device 17 is very high temperature and the intensity of its thermal emissions is significantly greater than the intensity of thermal emissions from melt pool 32, and the surrounding areas of component 22. Similarly, thermal emissions intensity at and near the center of melt pool 32 may be significantly greater than the intensity of thermal emissions near the edge of melt pool 32 and in areas surrounding melt pool 32. Because of this, it may be difficult to accurately measure temperature and cooling rate of areas near the edge of melt pool 32 and in areas surrounding melt pool 32. This results in difficulty predicting and controlling microstructure of the additively manufactured component 22.

Optical system 80 may include an imaging device and an associated optical train, which senses emissions at or near component 22 during the additive manufacturing technique. For example, optical system 80 may include a visible light imaging device, an infrared imaging device, or an imaging device that is configured (e.g., using a filter) to image a specific wavelength or wavelength range.

The optical train may include one or more reflective, refractive, diffractive optical components configured to direct light to the imaging device. For example, the optical train may be configured to direct light from near component 22 and/or melt pool 32 to the imaging device. In some examples, at least a portion of the optical train is coaxial with the axis at which energy delivery device 16 outputs energy, and the at least a portion of the optical train may be attached to or otherwise configured to move with the portion of energy delivery device 16 that directs or focuses energy 34 at or near the surface of component 22. In this way, optical system 80 may move with energy delivery device 16 and track melt pool 32 as melt pool 32 moves across component 22, without needing to correct for any offsets between energy delivery device 16 and optical system 80 and/or needing to correct for geometry of component 22. In other examples, the optical train may not be coaxial with the axis at which energy delivery device 16 outputs energy 34, and computing device 12 may be configured to compensate for the offset and any affects this may have on the imaging, including shadowing, interference, geometry of component 22, or the like.

Optical system 80 may include an occulting device. The occulting device is configured to reduce or block emissions (e.g., thermal emissions) that originate from the energy output by energy delivery device 16 and/or near a center of melt pool 32, which otherwise obfuscate emissions from solidifying regions of material at or near the edge of melt pool 32 and outside of melt pool 32. The occulting device may be a rigid occulting device or a dynamic occulting device. A rigid occulting device reduces or blocks emissions from a fixed region, e.g., from the energy 34 output by energy delivery device 16. For instance, a rigid occulting device may include a device with fixed dimensions that is opaque to wavelengths of interest. As another example, a rigid occulting device may include an apodizing lens in which a center of the lens if substantially opaque to wavelengths of interest and opacity decreases as a function of radius.

A dynamic occulting device is configured to be controlled to occult different regions, e.g., different sizes and/or shapes. A dynamic occulting device may include a rigid occulting device that is mounted to a device that can translate the rigid occulting device along and/or perpendicularly to the optical axis. As another example, a dynamic occulting device may include an opaque and viscous liquid, such as mercury, contained between two substrates. The substrates are substantially transparent to the wavelength(s) of interest. One or both of the substrates may be movable relative to the other substrate to control the distance between the substrates. By reducing the distance between the substrates, the size of the occulting region may increase. By increasing the distance between the substrates, the size of the occulting region may decrease. As a third example, a dynamic occulting device may include a digital micromirror device. Computing device 12 may be configured to control the micromirrors of the digital micromirror device to direct emissions that originate from energy 34 output by energy delivery device 16 and/or near a center of the melt pool away from the imaging device. A digital micromirror device may enable control of both the size and shape of the region of emissions that are occulted.

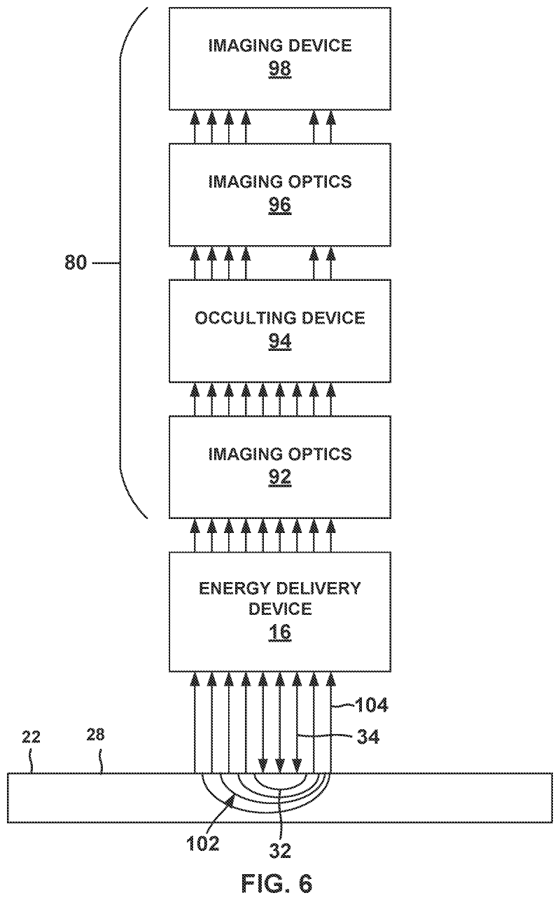

FIG. 6 is a conceptual block diagram illustrating an example optical system 80 for observing thermal emissions at and/or around a melt pool 32 and or a focused spot on a build surface 28 where a melt pool is not formed (e.g., by second energy delivery device 17, FIGS. 1 and 5) formed during an additive manufacturing technique. Optical system 80 includes an optical train that includes first imaging optics 92, occulting device 94, second imaging optics 96, and imaging device 98. Imaging device 98 may be any suitable imaging device, including, for example, a visible light imaging device, an infrared imaging device, an imaging device that is configured (e.g., using a filter) to image a specific wavelength or wavelength range, a two color pyrometry imaging device, or the like.

First and second imaging optics 92 and 96 may each include one or more optical devices used to direct light to imaging device 98. For example, First and second imaging optics 92 and 96 may each include one or more refractive optical device (e.g., a lens), one or more reflective optical device (e.g., a mirror), one or more diffractive optical devices (e.g., a grating), one or more dichroic optical devices (e.g., a dichroic filter or mirror), or the like. Although two sets of imaging optics 92 and 98 are shown in FIG. 2, in other examples, system 80 may include a single set of imaging optics or more than two sets of imaging optics.

Occulting device 94 is positioned within the optical train between first imaging optics 92 and second imaging optics 96. In other example, occulting device 94 may be positioned between imaging device 98 and imaging optics 96 or after before imaging optics 92. In some examples, occulting device 94 is positioned as the optical component nearest imaging device. This effectively results in removal of the portion of the image which occulting device 94 blocks. In other examples, occulting device 94 is positioned at another position within the optical train 80 where the image of component 22 resolves. Imaging optics 96 then may be configured to image occulting device 94 onto imaging device 98.

As shown in FIG. 6, in some examples, at least a portion of optical system 80 is coaxial with the axis at which energy delivery device 16 outputs energy 34 (i.e., a central longitudinal axis). For example, at least a portion of second imaging optics 92 (e.g., the portion at which emitted light 104 is incident upon second imaging optics 92) may be coaxial with the axis at which energy delivery device 16 outputs energy 34. This may reduce image manipulation that otherwise may be applied to the resulting image to correct for geometry of component 22, angular offset of optical system 80 relative to energy delivery device 16, shadowing due to the angular offset, interference, or the like. In other examples, optical system 80 (e.g., the portion at which thermal emissions 104 are incident upon second imaging optics 92) may not be coaxial with the axis at which energy delivery device 16 outputs energy 34, and computing device 12 (FIG. 1) or another computing device may be configured to manipulate the resulting image to compensate for geometry of component 22, angular offset of optical system 80 relative to energy delivery device 16, shadowing due to the angular offset, interference, or the like.

FIG. 6 also illustrates energy delivery device 16 outputting energy 34, which is incident upon component 22 and results in formation of melt pool 32. Surrounding melt pool is a cooling zone 102, in which temperature gradients from the temperature of melt pool 32 to ambient temperature are present. As shown in FIG. 6, melt pool 32 and cooling zone 102 emit thermal emissions 104 (e.g., thermal radiation), which travel through optical system 80 to imaging device 98, which images the thermal emissions 104. Occulting device 94 occults (e.g., reduces the intensity of or substantially eliminates) thermal emissions 104 from a selected region, e.g., a region corresponding to energy 34 and at least a portion of melt pool 32. This may allow imaging device 98 to more effectively image relatively lower intensity thermal emissions from at or near the edge of melt pool 32 and within cooling zone 102. This may enable more accurate measurement of temperatures within the cooling zone 102, and heat flow within cooling zone 102.

Returning to FIG. 5, system 10 also includes melt pool monitor (“MP monitor”) 82. Melt pool monitor 82 may include a sensor for monitoring a characteristic of melt pool 32. The sensor may include an imaging system, such as a visual or thermal camera, e.g., camera to visible light or infrared (IR) radiation. A visible light camera may monitor the geometry of the melt pool, e.g., a width, diameter, shape, or the like. A thermal (or IR) camera may be used to detect the size, temperature, or both of the melt pool. In some examples, a thermal camera may be used to detect the temperature of the melt pool at multiple positions within the melt pool, such as a leading edge, a center, and a trailing edge of the melt pool. In some examples, the imaging system may include a relatively high speed camera capable of capturing image data at a rate of tens or hundreds of frames per second or more, which may facilitate real-time detection of the characteristic of the melt pool.

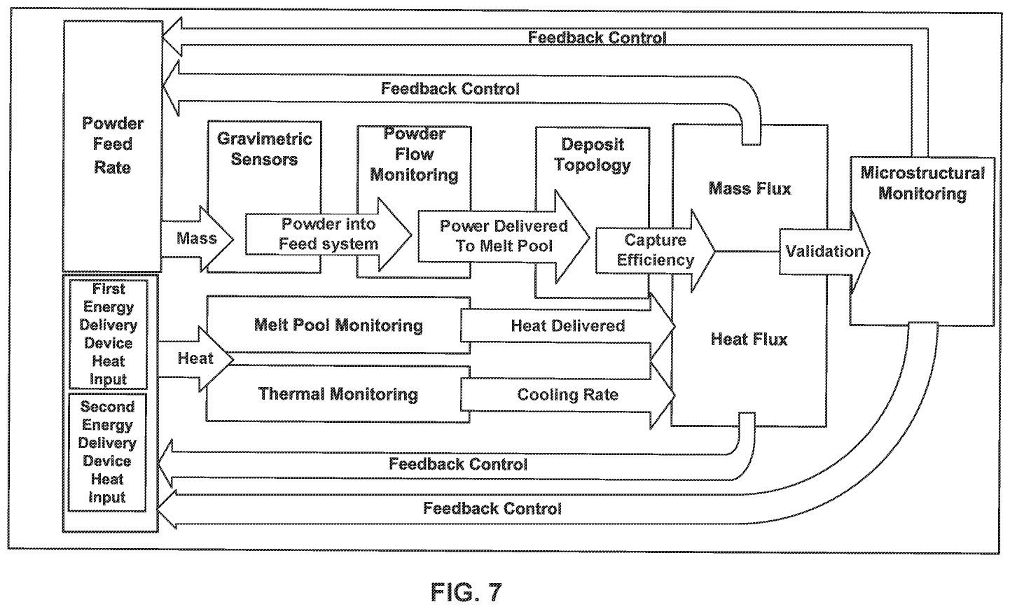

FIG. 7 is a process flow diagram illustrating a mass flux and heat flux monitoring and control technique. The technique of FIG. 7 may be implemented by system 10 of FIGS. 1 and 5 and will be described with concurrent reference to FIGS. 1 and 5. However, it will be appreciated that system 10 may perform other techniques and the technique of FIG. 7 may be performed by other systems. For example, system 100 of FIG. 2 may perform the described technique.

One or more computing devices 12 may be configured to control a powder feed rate output by powder source 42 (see top left of FIG. 7). For instance, one or more computing devices 12 may be configured to control an agitator of powder source 42, a gas flow rate of gas flowing through powder source 42, a position of one or more valves within flow path 46, or the like to control a powder feed rate output by powder source 42.

One or more computing devices 12 may be configured to receive data from one or more mass flow monitoring sensors, including PFMS 18, powder flow mass sensor 44, and/or topology sensor 48. Data received from powder flow mass sensor 44 indicates a mass flow of powder from powder source 42 to powder delivery device. Data from PFMS 18 indicates a mass flow of powder in powder stream 30 between powder delivery device 14 to adjacent melt pool 32. Data from topology sensor 48 indicates powder mass captured by melt pool 32 and added to component 22.

One or more computing devices 12 may calculate one or more mass flow-related metrics based on the data received from PFMS 18, powder flow mass sensor 44, and/or topology sensor 48. For example, one or more computing devices 12 may determine a capture efficiency by determining a fraction or percentage of powder from powder stream 30 that is captured by melt pool 32 and added to component 22, e.g., by dividing the powder mass captured by melt pool 32, as determined based on data from topology sensor, into the mass flow determined based on data received from PFMS 18.

Further, one or more computing devices 12 may determine an overall mass flux using the data received from PFMS 18, powder flow mass sensor 44, and/or topology sensor 48. One or more computing devices 12 then may use the overall mass flux as an input to the control algorithm used to control the powder feed rate output by powder source 42 (see top left of FIG. 7).

Similarly, one or more computing devices 12 may be configured to control first energy delivery device 16 and second energy delivery device 17 to deliver energy 34 to first layer 24 to establish a given heat input (see bottom left of FIG. 7). For example, one or more computing device 12 may control one or more operating parameters of energy delivery device 16 and/or second energy delivery device 17, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22). In some examples, computing device 12 may be configured to operate one of the energy delivery devices (e.g., first energy delivery device 16) at a constant heat input and to control second energy delivery device 17 to modify (e.g., selectively tailor) properties of a first portion P1 and/or a second portion P2. For example, second energy delivery device 17 may input thermal energy to portion P2 to modify, for example, a hardness of portion P2 of component 22. In this way, component 22 may be thermally treated in-situ to provide functional gradation to component 22.

One or more computing devices 12 may be configured to receive from one or more heat sensors, such as optical system 80 and/or melt pool monitor 82. One or more computing devices may determine a cooling rate and associated heat from using data from optical system 80 and may determine a heat input into component using a size and/or temperature of melt pool 32 as observed by melt pool monitor 15, probe 21, or both. One or more computing devices 12 may be configured to capture data from melt pool monitor 15, probe 21 throughout a period of time (e.g., at a first point in time, a second point in time, a third point in time, etc.). One or more computing devices 12 may be configured to determine a thermal history of portions P1, P2 of component 22 based on the captured data. One or more computing devices 12 then may use the thermal history as an input to the control algorithm used to control first energy delivery device 16, second energy delivery device 17, or both. (see left of FIG. 7).

In some examples, microstructural monitoring device 19 may be configured to sense, capture, and output to one or more computing device 12 data representative of a microstructure of portions P1, P2 of component 22. One or more computing devices 12 may be configured to determine a microstructure of portions P1, P2 based on the captured data. One or more computing devices 12 may then use the determined microstructure as an input to the control algorithm used to control first energy delivery device 16, second energy delivery device 17, or both. In some examples, for example of MMD 19 meets a threshold level in one or more microstructural characteristics, one or more computing devices 12 may be configured to continue the build based on the validated microstructure of component 22. In some examples, if one or more computing devices 12 determines that the component microstructure does not meet a threshold level, one or more computing devices may be configured to cause system 10 to stop before building a flawed component 22, or may be configured to output a display indicating an improper microstructure.

In some examples, one or more computing devices 12 also may use the deposit topology (captured powder mass) and/or capture efficiency metric in the determination of the heat flux, as the added powder mass and quench effects associated with the captured powder affect the cooling rate.

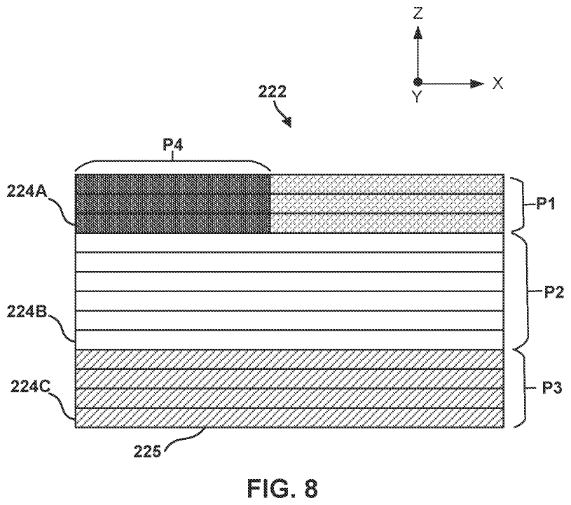

FIG. 8 is a conceptual and schematic diagram illustrating an example additively-manufactured, functionally-graded component 222. Component 222 includes a layer-by-layer built component body 225, and thus includes layers 224A, 224B, and 224C. Component 222 is described as being formed in-situ by system 10 of FIGS. 1 and 5, but it should be understood that system 100 of FIG. 2 may be used to form component 222. Component 222 includes portions P1, P2, P3, and P4 which are formed by modification of the amount of energy delivered to first energy source 16 or second energy source 17. In the illustrated example of FIG. 8, each of portions P1, P2, P3, and P4 each differ in at least one of a strength, a hardness, a ductility, or a microstructure from at least one of the other portions. wherein forming the first portion and the second portion comprises:

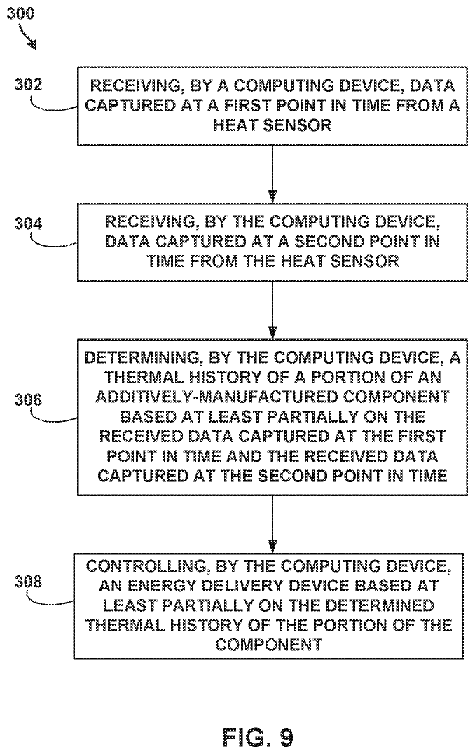

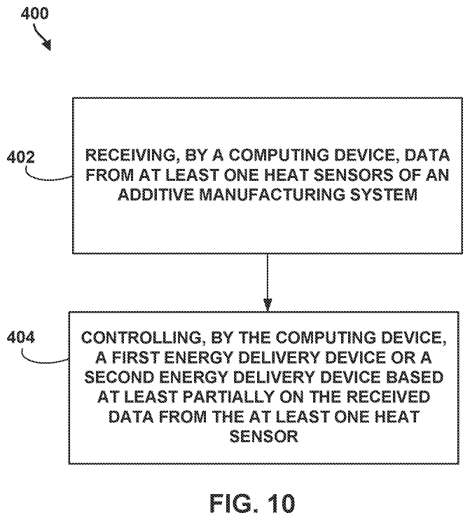

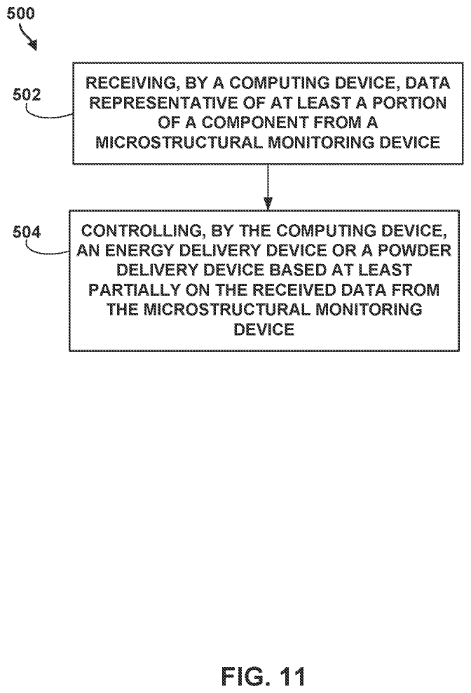

FIG. 9 is a flow diagram illustrating example technique 300 according to the present disclosure. Technique 300 is described with respect to system 10 of FIGS. 1 and 5, but technique 300 may be performed with system 100 of FIG. 2, or with other additive manufacturing systems. System 10 of FIGS. 1 and 5 and system 100 of FIG. 2 may be used t perform other techniques, such as technique 400 of FIG. 10 or technique 500 of FIG. 11.

Technique 300 includes receiving, by computing device 12, data captured at a first point in time from temperature probe 21 representative of the temperature of portion P2 of additively-manufactured component 22 of additive manufacturing system 10 (302). Technique 300 may include directing powder delivery device 14 to direct powder stream 30 toward melt pool 32 in build surface 28 of additively-manufactured component 22 under control of computing device 12 and delivering energy 34 to build surface 28 via primary energy deliver device 16 to form melt pool 32 under control of computing device 12. In some examples, technique 300 further includes directing energy 34 from secondary energy delivery device 17 to build surface 28 to impart desired properties to portion P2 of component 22.

Technique 300 includes receiving, by computing device 12, data captured at a second point in time from temperature probe 21 indicative of a temperature of portion P2 (304). In some examples, technique 300 may include receiving data captured at a third point in time from temperature probe 21, data captured at a fourth point in time from temperature probe 21, or the like. In some examples, computing device 12 may cause a measurement of the temperature in portion P2 to be captured and stored at defined points in time (e.g., separated by one second, two seconds, 1 minute, 2 minutes, or the like.) Accordingly, temperature or other data indicative of heat flux in system 10 and component 22 may be captured and stored throughout some or all of an additive manufacturing process to build component 22. The captured data may correlate to individual portions of component 22.

Technique 300 may include analyzing the data captured by probe 21 of portion P2. Technique 300 may include determining, by computing device 12, a thermal history of the component based at least partially on the received data captured at the first point in time and the received data captured at the second point in time (306). Technique 300 may further include controlling, by computing device 12, primary energy delivery device 16 or secondary energy delivery device 17 based at least partially on the determined thermal history of the component (308). For example, computing device 12 may determine, based on the thermal history of portion P2, that energy 34 should be added via secondary energy delivery device 12 to portion P2 to modify the desired cooling or solidification rate of portion P2 to generate the desired strength, ductility, porosity, and/or microstructure of portion P2 of component 22. For example, computing device 12 may cause the power, travel speed, spot size, or power density of energy delivery device 17 to more closely conform to the desired thermal history of portion P2, based on a model, a machine learning algorithm, or the like.

FIG. 10 is a flow diagram illustrating example technique 400 according to the present disclosure. Technique 400 includes receiving, by computing device 12, data from heat sensor 21 configured to measure a temperature of a portion P2 of component 22 being built by additive manufacturing system 10 (402). Technique 400 may include directing powder delivery device 14 to direct powder stream 30 toward melt pool 32 in build surface 28 of additively-manufactured component 22 under control of computing device 12 and delivering energy 34 to build surface 28 via primary energy deliver device 16 to form melt pool 32 under control of computing device 12.

Technique 400 includes controlling, by the one or more computing devices, the first energy delivery device 16 or second energy device 17 based at least partially on the received data from heat sensor 21 to provide functionally-graded characteristics to additively-manufactured component 22, in-situ, through modification of the amount of thermal energy 34 delivered by first energy delivery device 16 or second energy delivery device 17 (404).

FIG. 11 is a flow diagram illustrating example technique 500 according to the present disclosure. Technique 500 includes receiving, by computing device 12 of system 10, data representative of a microstructure of portion P2 of additively-manufactured component 22 from MMD 19 (502). Technique 500 further includes controlling, by computing device 12, at least one of powder delivery device 14, primary energy device 16, or secondary energy delivery device 17 based at least partially on the received data from microstructural MMD 19 (504). In some examples, computing device 12 may control first energy delivery device 16 and/or second energy delivery device 17 by modifying at least one of a power, a travel speed, a spot size, or a power density of first energy delivery device 16 and/or second energy delivery device 17. In some examples, computing device 12 may control powder delivery device 14 by modifying at least one of a power, a travel speed, a gas flow rate, or a mass flow rate of the powder.

In some examples, technique 500 may include operating at least one of an X-Ray device, a computed tomography (CT) device, an ultrasound device, or an acoustic monitoring device as MMD 19. In some examples, the captured data may be representative of at least one of a modulus of elasticity, a microstructural texture, or a porosity of portion P2 of component 22.

In some examples, computing device 12 may compare data captured by MMD 19 to a model or expected value table for an ideal additively-manufactured component 22. Additionally, or alternatively, computing device 12 may execute a machine learning algorithm, which may be trained on data generated by microstructural monitoring device 19. In some examples, the machine learning algorithm may be used to correlate the data generated by MMD19 to data indicative of materials quality of powder in the powder stream (58, FIG. 2).

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following examples and claims.

Example 1: An additive manufacturing system includes an energy delivery device configured to deliver energy to a build surface of a component to form a melt pool in the build surface of the component; a powder delivery device configured to direct a powder stream toward the melt pool; a microstructural monitoring device configured to capture data representative of a microstructure of at least a portion of the component; and a computing device configured to: receive data from the microstructural monitoring device, and control at least one of the powder delivery device or the energy delivery device based at least partially on the data received from the microstructural monitoring device.

Example 2: The additive manufacturing system of example 1, wherein the microstructural monitoring device comprises at least one of an X-Ray device, a computed tomography (CT) device, an ultrasound device, or an acoustic monitoring device.

Example 3: The additive manufacturing device of any of examples 1 and 2, wherein the captured data from the microstructural monitoring device is representative of at least one of a modulus of elasticity, a microstructural texture, or a porosity.

Example 4: The additive manufacturing device of any of examples 1 through 3 wherein the computing device is configured to control the energy delivery device by modifying at least one of a power, a travel speed, a spot size, or a power density of the energy delivery device.

Example 5: The additive manufacturing device of any of examples 1 through 4, wherein, based on a model of at least a portion of the component, the computing device is configured to control the powder delivery device by modifying at least one of a power, a travel speed, a gas flow rate, or a mass flow rate of the powder.

Example 6: The additive manufacturing system of any of examples 1 through 5, further includes an illumination device configured to illuminate at least some powder in the powder stream between the powder delivery device and the build surface; and an imaging device configured to image the illuminated powder at an image plane that intersects a longitudinal axis of a deposition head, and wherein the one or more computing devices is configured to determine a mass flow rate of powder from the powder delivery device using data from the powder flow monitoring system.

Example 7: The additive manufacturing system of any of examples 1 through 6, further comprising a powder source mass sensor configured to measure a mass of powder leaving a powder source for delivery to the powder delivery device.

Example 8: The additive manufacturing system of any of examples 1 through 7, further comprising a topology sensor configured to measure a topology of material added to the melt pool, wherein the one or more computing devices is further configured to determine a mass of powder added to the melt pool based on the topology of the material added to the melt pool and a density of the powder.

Example 9: The additive manufacturing system of example 8, wherein the one or more computing devices is further configured to determine a capture efficiency by dividing the mass of powder added to the melt pool by the mass of powder leaving the powder delivery device or dividing a mass rate of powder added to the melt pool by a mass flow rate of powder leaving the powder delivery device.

Example 10: The additive manufacturing system of example 9, wherein the one or more computing devices is configured to determine an overall heat flux based on data from at least one heat sensor and the capture efficiency.

Example 11: The additive manufacturing system of any of examples 1 through 10, wherein the computing device stores and is configured to execute a machine learning algorithm, and wherein the machine learning algorithm is trained on data generated by the microstructural monitoring device.

Example 12: The additive manufacturing system of example 11, wherein the machine learning algorithm is used to correlate the data generated by the microstructural monitoring device to data indicative of materials quality of powder in the powder stream.

Example 13: The additive manufacturing system of any of examples 1 through 12, wherein the energy delivery device is a first energy delivery device, and further comprising a second energy delivery device configured to deliver energy to the build surface of the component.

Example 14: The additive manufacturing system of example 13, wherein: the first energy deliver device is coincident with a central longitudinal axis of a deposition head, and the second energy delivery device is not coincident with the central longitudinal axis of the deposition head.

Example 15: The additive manufacturing system of example 14, wherein: the first energy delivery device comprises a laser, and the second energy delivery device comprises a laser, an induction heater, an infrared heater, a gas impingement device, or a microwave heater.

Example 16: The additive manufacturing system of any of examples 13 through 15, further comprising a third energy delivery device.

Example 17: The additive manufacturing system of any of examples 13 through 16, wherein the second energy delivery device is configured to deliver energy to the build surface of the component simultaneously with the first energy delivery device delivering energy to the build surface of the component.

Example 18: The additive manufacturing system of any of examples 13 through 17, wherein the second energy delivery device is configured to deliver energy to the build surface of the component subsequent to the first energy deliver device delivering energy to the build surface of the component.

Example 19: A method includes receiving, by a computing device of an additive manufacturing system, data representative of at least a portion of a component being built from a microstructural monitoring device of the additive manufacturing system, the additive manufacturing system further includes a powder delivery device configured to direct a powder stream toward a melt pool in a build surface of an additively-manufactured component, an energy delivery device configured to deliver energy to the build surface of the additively-manufactured component to form the melt pool, and controlling, by the computing device, at least one of the powder delivery device or the energy device based at least partially on the received data from the microstructural monitoring device.

Example 20: The method of example 19, wherein the microstructural monitoring device comprises at least one of an X-Ray device, a computed tomography (CT) device, an ultrasound device, or an acoustic monitoring device.

What is claimed is:

1. An additive manufacturing system comprising:
an energy delivery device configured to deliver energy to a build surface of a component to form a melt pool in the build surface of the component;
a powder delivery device configured to direct a powder stream toward the melt pool;
a microstructural monitoring device configured to capture data representative of a microstructure of at least a portion of the component; and
a computing device configured to:
receive data from the microstructural monitoring device, and
control at least one of the powder delivery device or the energy delivery device based at least partially on the data received from the microstructural monitoring device.

2. The additive manufacturing system of claim 1, wherein the microstructural monitoring device comprises at least one of an X-Ray device, a computed tomography (CT) device, an ultrasound device, or an acoustic monitoring device.

3. The additive manufacturing device of claim 1, wherein the captured data from the microstructural monitoring device is representative of at least one of a modulus of elasticity, a microstructural texture, or a porosity.

4. The additive manufacturing device of claim 1 wherein the computing device is configured to control the energy delivery device by modifying at least one of a power, a travel speed, a spot size, or a power density of the energy delivery device.

5. The additive manufacturing device of claim 1, wherein, based on a model of at least a portion of the component, the computing device is configured to control the powder delivery device by modifying at least one of a power, a travel speed, a gas flow rate, or a mass flow rate of the powder.

6. The additive manufacturing system of claim 1, further comprising a powder flow monitoring system comprising:
an illumination device configured to illuminate at least some powder in the powder stream between the powder delivery device and the build surface; and
an imaging device configured to image the illuminated powder at an image plane that intersects a longitudinal axis of a deposition head, and wherein the one or more computing devices is configured to determine a mass flow rate of powder from the powder delivery device using data from the powder flow monitoring system.

7. The additive manufacturing system of claim 1, further comprising a powder source mass sensor configured to measure a mass of powder leaving a powder source for delivery to the powder delivery device.

8. The additive manufacturing system of claim 1, further comprising a topology sensor configured to measure a topology of material added to the melt pool, wherein the one or more computing devices is further configured to determine a mass of powder added to the melt pool based on the topology of the material added to the melt pool and a density of the powder.

9. The additive manufacturing system of claim 8, wherein the one or more computing devices is further configured to determine a capture efficiency by dividing the mass of powder added to the melt pool by the mass of powder leaving the powder delivery device or dividing a mass rate of powder added to the melt pool by a mass flow rate of powder leaving the powder delivery device.

10. The additive manufacturing system of claim 9, wherein the one or more computing devices is configured to determine an overall heat flux based on data from at least one heat sensor and the capture efficiency.

11. The additive manufacturing system of claim 1, wherein the computing device stores and is configured to execute a machine learning algorithm, and
wherein the machine learning algorithm is trained on data generated by the microstructural monitoring device.

12. The additive manufacturing system of claim 11, wherein the machine learning algorithm is used to correlate the data generated by the microstructural monitoring device to data indicative of materials quality of powder in the powder stream.

13. The additive manufacturing system of claim 1, wherein the energy delivery device is a first energy delivery device, and further comprising a second energy delivery device configured to deliver energy to the build surface of the component.

14. The additive manufacturing system of claim 13, wherein:
the first energy deliver device is coincident with a central longitudinal axis of a deposition head, and
the second energy delivery device is not coincident with the central longitudinal axis of the deposition head.

15. The additive manufacturing system of claim 14, wherein:
the first energy delivery device comprises a laser, and
the second energy delivery device comprises a laser, an induction heater, an infrared heater, a gas impingement device, or a microwave heater.

16. The additive manufacturing system of claim 13, further comprising a third energy delivery device.

17. The additive manufacturing system of claim 13, wherein the second energy delivery device is configured to deliver energy to the build surface of the component simultaneously with the first energy delivery device delivering energy to the build surface of the component.

18. The additive manufacturing system of claim 13, wherein the second energy delivery device is configured to deliver energy to the build surface of the component subsequent to the first energy deliver device delivering energy to the build surface of the component.

19. A method comprising:
receiving, by a computing device of an additive manufacturing system, data representative of at least a portion of a component being built from a microstructural monitoring device of the additive manufacturing system, the additive manufacturing system further comprising:
a powder delivery device configured to direct a powder stream toward a melt pool in a build surface of an additively-manufactured component,
an energy delivery device configured to deliver energy to the build surface of
the additively-manufactured component to form the melt pool, and
controlling, by the computing device, at least one of the powder delivery device or the energy device based at least partially on the received data from the microstructural monitoring device.

20. The method of claim 19, wherein the microstructural monitoring device comprises at least one of an X-Ray device, a computed tomography (CT) device, an ultrasound device, or an acoustic monitoring device.
